(19) United States
(12) Patent Application Publication
(10) Pub. No.: US 2015/0356472 A1
(43) Pub. Date: Dec. 10, 2015

(54) CONFLATION BASED POSITION DETERMINATION OF OUTSIDE PLANT ELEMENTS

(71) Applicant: Verizon Patent and Licensing Inc., Arlington, VA (US)

(72) Inventors: Sireesh Mutharaju, Chennai (IN); Shunmugapriya Sivabalan, Chennai (IN); Shan Sasidharan, Chennai (IN); Radhika Sundareswaran, Pollachi (IN); Arumugasankar Ramakrishnan, Chennai (IN)

(21) Appl. No.: 14/319,556

(22) Filed: Jun. 30, 2014

Related U.S. Application Data
(60) Provisional application No. 62/010,147, filed on Jun. 10, 2014.

(51) Int. Cl. G06Q 10/06

(52) U.S. Cl. CPC G06Q 10/06

(57) ABSTRACT

A device may facilitate the accurate position determination of outside plant (OSP) elements within telecommunication network infrastructures. The device may partition a first map into a plurality of segments, where the first map represents a layout for outside plant (OSP) elements within a region. The device may identify at least one segment that is unsuitable for a geometric analysis, and subdivide at least one identified segment into smaller segments, until the smaller segments are suitable for the geometric analysis. The device may perform the geometric analysis on the segments in the first map and on spatially corresponding segments in the geocoded map; and compare the geometric analysis of the segments in the first map and the geometric analysis of the spatially corresponding segments in the geocoded map.

### RELATED APPLICATION

This U.S. patent application claims priority under 35 U.S.C. §119 to U.S. Provisional Patent Application No. 62/010,147, entitled “CONFLATION BASED POSITION DETERMINATION OF OUTSIDE PLANT ELEMENTS,” and filed on Jun. 10, 2014, the disclosure of which is expressly incorporated herein by reference in its entirety.

### BACKGROUND

Providers of telecommunication services are involved in ongoing efforts to maintain and improve their infrastructures to provide services to their customers. Accurate knowledge of the locations of infrastructure equipment, also known as outside plant elements (OSP), is used by the service provider for initial design efforts and ongoing support operations. Conventional techniques for obtaining accurate position information of OSPs may be labor intensive and involve a variety of datasets. Some datasets may undergo conversions into more desirable computer compatible formats, and then be manually checked for placement errors of OSPs. As the telecommunication infrastructures grow and increase in complexity, the efforts to determine accurate position information of OSPs may become increasingly demanding and labor intensive.

### BRIEF DESCRIPTION OF THE DRAWINGS

FIG. 1 is a diagram illustrating an exemplary land base map showing a layout of OSP elements in a region;

FIG. 2 is a diagram illustrating an exemplary geocoded map showing the layout of the OSP elements covering an area substantially overlapping the region shown in the land base map of FIG. 1.

FIGS. 3A and 3B illustrate close ups of the geocoded map before and after the position correction of an OSP element.

FIG. 4 is a diagram of a segment illustrating an exemplary approach for computing the deviations of spatial metrics used in geometric analysis;

FIG. 5 is a diagram showing an exemplary graphical output of the results of the comparisons based on geometric analysis for the appropriate segments;

FIG. 6 is a is a diagram illustrating exemplary components for a device which facilitates the accurate position determination of OSP elements;

FIG. 7 is a flow diagram of an exemplary process for facilitating accurate position determination of OSP elements;

FIG. 8 a flow diagram of an exemplary process for performing geometric analysis based on the OSP elements; and

FIG. 9 is a diagram illustrating an exemplary geocoded map having segments of various sizes superimposed thereon.

### DETAILED DESCRIPTION OF PREFERRED EMBODIMENTS

The following detailed description refers to the accompanying drawings. The same reference numbers in different drawings may identify the same or similar elements.

Embodiments described herein facilitate the accurate position determination of outside plant (OSP) elements within telecommunication network infrastructures. As will be explained in more detail below, embodiments may automatically categorize deviations in OSP element positions over two-dimensional segments representing smaller sub-areas within a specified region, and also flag segments where one or more OSP elements exhibit unacceptable position errors. The segments may be displayed in geocoded maps, where the geocoded maps can be generated using a conversion and conflation process. The automatic categorization thus permits an operator to efficiently verify the accuracy of vast amounts of map data. Moreover, flagging the segments associated with unacceptable position errors allows an operator to focus on the more troublesome segments which may require manual intervention to correct.

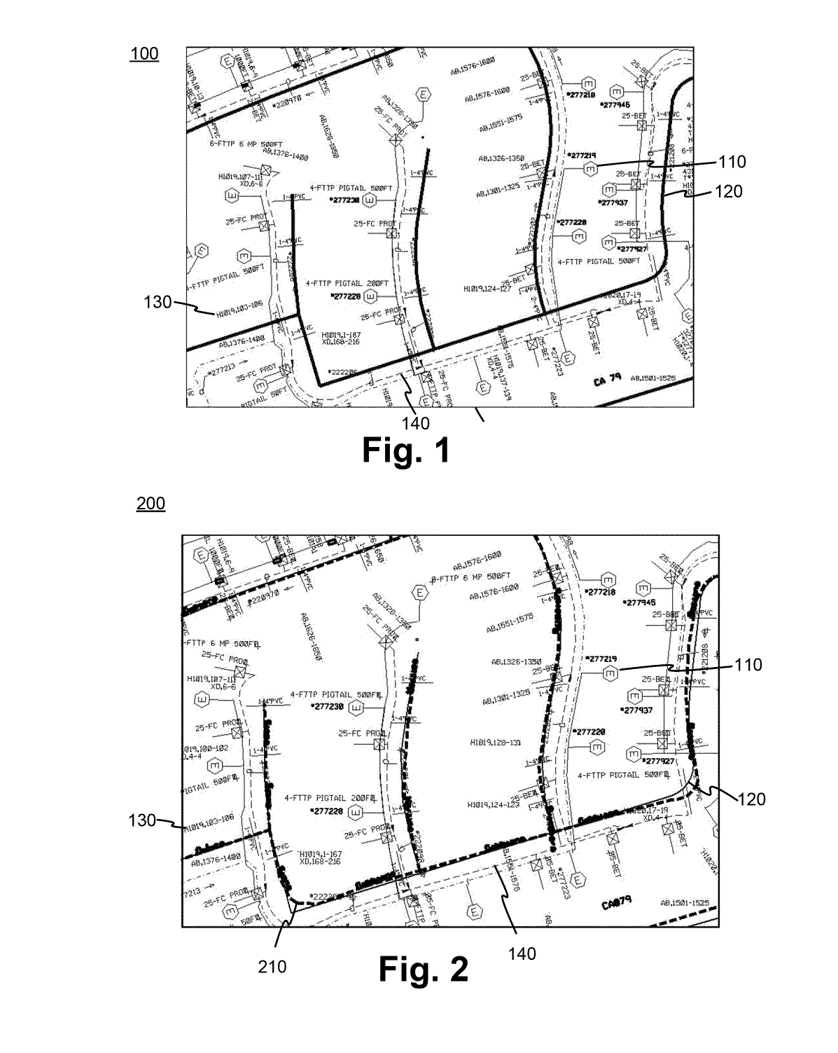

For example, embodiments for determining accurate positions of OSP elements may initially include partitioning a first map, which, for example, may be a land base map as shown in FIG. 1, into a plurality of segments. In one embodiment, the segments may be, for example, rectilinear grids. Each segment may be further analyzed to identify segments which are unsuitable for subsequent geometric analysis. In some instances, a “problem” segment may be identified as being unsuitable if, for example, the segment contains multiple OSP elements which cannot be isolated for analysis. The problem segment may be “simplified” by subdividing the segment into smaller segments. The subdividing process of the segments can be iterative, and may continue to divide the previously divided segments into increasingly smaller segments, until the problem segment is suitable for geometric analysis.

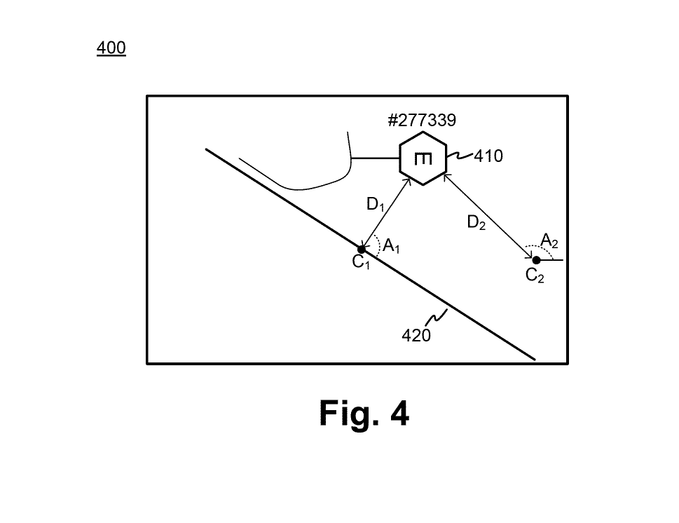

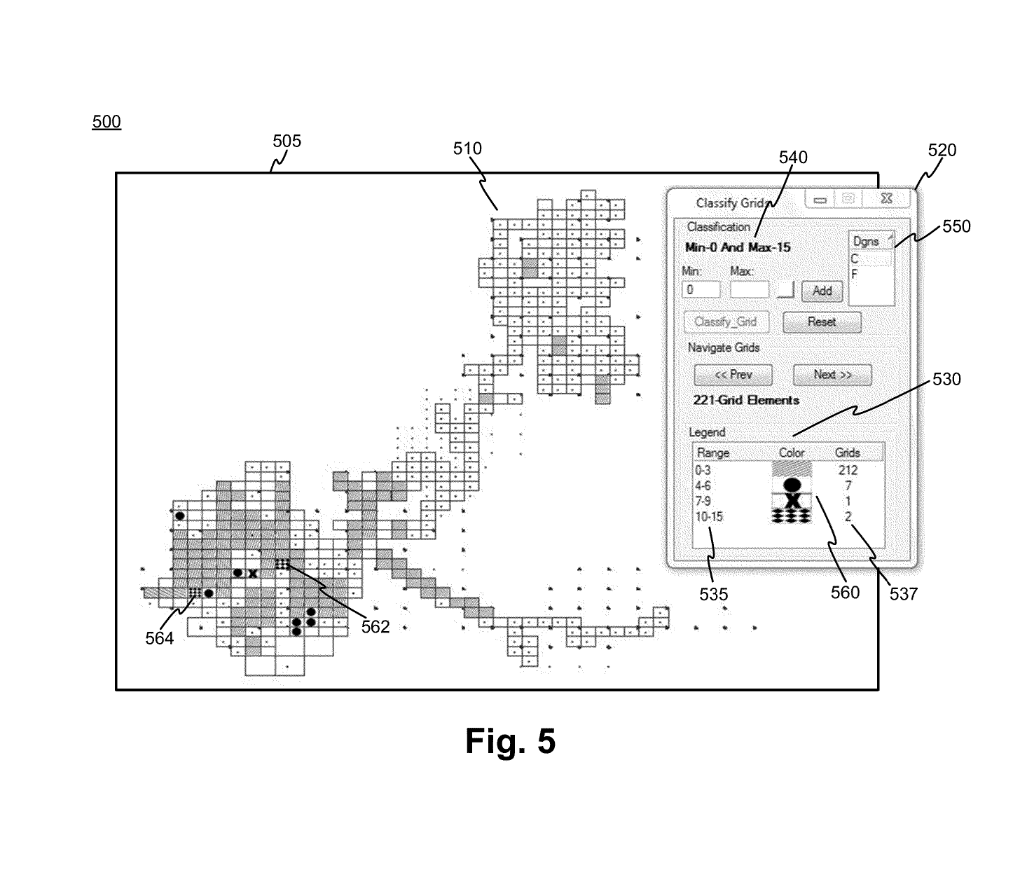

Once all the segments in the first map are determined as being suitable, the geometric analysis may be performed. Geometric analysis may include computing spatial metric(s) associated with OSP elements for the segments in the first map. Corresponding spatial metric(s) may be computed in a geocoded map, which may be generated from coordinate conversion and conflation of the first map. An example of a geocoded map is described below in relation to FIG. 2. The spatial metrics may include, for example, distances and angles of OSP elements with respect to control points, as exemplified in FIG. 4. Once determined, the spatial metrics associated with the first map and the geocoded map may be compared on a segment by segment basis. For example, the magnitude of the deviations of the spatial metrics may be determined, and sorted into different categories based ranges. The number of segments falling into each category may be counted and displayed. Additionally, the categories may be visually labeled and each segment may be displayed on the geocoded map based on its visual labeling. FIG. 5 illustrates one example of such an output, which allows an operator to immediately identify which categories the segments fall into based on their color, and quickly isolate the problem segments.

As used herein, conflation may be defined as combining geographic information (e.g., mapping data) from different sources which represent a common region (e.g., the different maps may overlap a particular geographic area). The combined sources may improve mapping accuracy, minimize redundancy, and/or reconcile data conflicts. The different sources of geographic information may be created at different times using different sensors and/or techniques, and may have different levels of accuracy and precision.

As used herein an outside plant (OSP) element may be any element used in the design, realization, implementation and/or use of a telecommunications network, and may include, for example, terminals, cables, fiber, wireless towers, telephone poles, etc.

FIG. 1 is a diagram illustrating an exemplary land base map 100 showing a layout of OSP elements in a localized region. Land base map 100 shows the OSP elements with reference to streets and other reference points. For example, OSP element 110, which may be identified by a numeric label (e.g., #277219) and a hexagon inscribed with an “E,” may represent a terminal interconnected with other terminals via a cable shown as a solid line. OSP element 140, shown by a dotted line, may represent a segment of fiber or cable which can be buried along the side of a street 120. Other OSPs, such as OSP 130, may be represented by a block of identifying text on the map, where the center of the block of text approximates the location of the OSP in the region. Street 120 may also serve as a set of control points, which may be used in the conversion and conflation process to convert land base map 100 into a geocoded map. Moreover, street 120 may also be used as a reference to calculate spatial metrics used in performing the geometric analysis, which is described in more detail in regards to FIG. 4. In an embodiment, street 120 may be a Geographic Data Technology (GDT) street line. Land base map 100 may have other control points which also may be used to calculate spatial metrics, and/or in the conversion and conflation process. The positions of the control points may be accurately known and represented using coordinates in a standard reference frame. For example, the coordinates of control points may be provided in [latitude, longitude, altitude] coordinates in World Geodetic System 84 (WGS-84), which is the reference coordinate system used for position data provided by the Global Positioning System (GPS).

Traditionally, telecommunication companies have designed their networking infrastructures by dividing large geographic areas into manageable regions, and OSP network designers and drafters have used land base maps to design and plan the placement and interconnections of the OSP elements. After the telecommunication network has been realized for the region, land base map 100 may serve as documentation of the actual placement of the OSP elements. Some land base maps may have a long history, depending upon the region and age of its telecommunications network (e.g., New York City). Thus, many land base maps were originally developed on paper and subsequently converted into a digital a map dataset. Accordingly, the land base maps, and the placement of the OSP elements represented therein, are typically not as accurate as modern geocoded maps used in current Graphics Information Systems (GIS). When in digital form, land based maps 100 may be represented using the Intelligent Computer Graphics System/Integrated Data Distribution System (ICGS/IDDS) standards, or using the Mapping Application for Public Safety (MAPS), which are typically not compatible and/or not as accurate as modern GIS formats.

FIG. 2 is a diagram illustrating an exemplary geocoded map 200 showing the layout of the OSP elements covering an area substantially overlapping the region covered by land base map 100 shown in FIG. 1. Land base maps may be transformed to geocoded maps using a conventional coordinate conversion and conflation process. The use of geocoded maps increases the accuracy and provides compatibility with modern GIS databases and mapping software.

Embodiments herein may automatically perform the transformation by initially identifying OSP elements, for example, as shown in FIG. 1, OSP element 110 (terminal), OSP element 130 (represented by text block), and OSP element 140 (cable/fiber), and performing their coordinate conversion. The conversion may be done by performing measurements of OSP elements with respect to control points which are common to both land base map 100 and geocoded map 200. A common set of control points may be determined from GDT street line 120. The GDT street line 120 may serve as a reference for the conversion/conflation process, as it closely matches the accurate representation 210 of the street (shown as a dotted line) contained in the dataset of geocoded map 200. After conversion is performed, the data may be conflated so the land base map 100 and the geocoded map 200 coincide, as shown in FIG. 2.

For example, each OSP element may be converted with respect to GDT street line 120, and thus the conversion of OSP elements 110, 130, and 140 can be accomplished using of control points which make up GDT street line 120. This may be accomplished using conventional techniques (e.g., triangulating each OSP using control points common to both land base map 100 and geocoded map 200). Once coordinate conversion is complete, the determined values may be corrected using the conflation process, which effectively warps land based map 100 (i.e., performs “rubber sheeting” on the land based map), using, for example, GDT street line 120 as a reference. Conflation corrects for both linear and non-linear distortions in land base map 100.

In alternative embodiments, the conversion and conflation process may be performed prior to embodiments described herein, where the accuracy of the geocoded maps may be automatically verified and flagged using the previously converted and conflated data. In some instances, where high accuracy is desired, or where datasets may not be amenable to automatic processing, the conversion and conflation process may be performed manually. In such instances, the operator may generate additional control points to improve the conversion and conflation process.

As will be described in detail below, the position of some OSP elements may not be sufficiently accurate after the aforementioned conversion and conflation process. That is, in the geocoded map 200, the position error of one or more OSP elements may be significant enough to warrant manual correction.

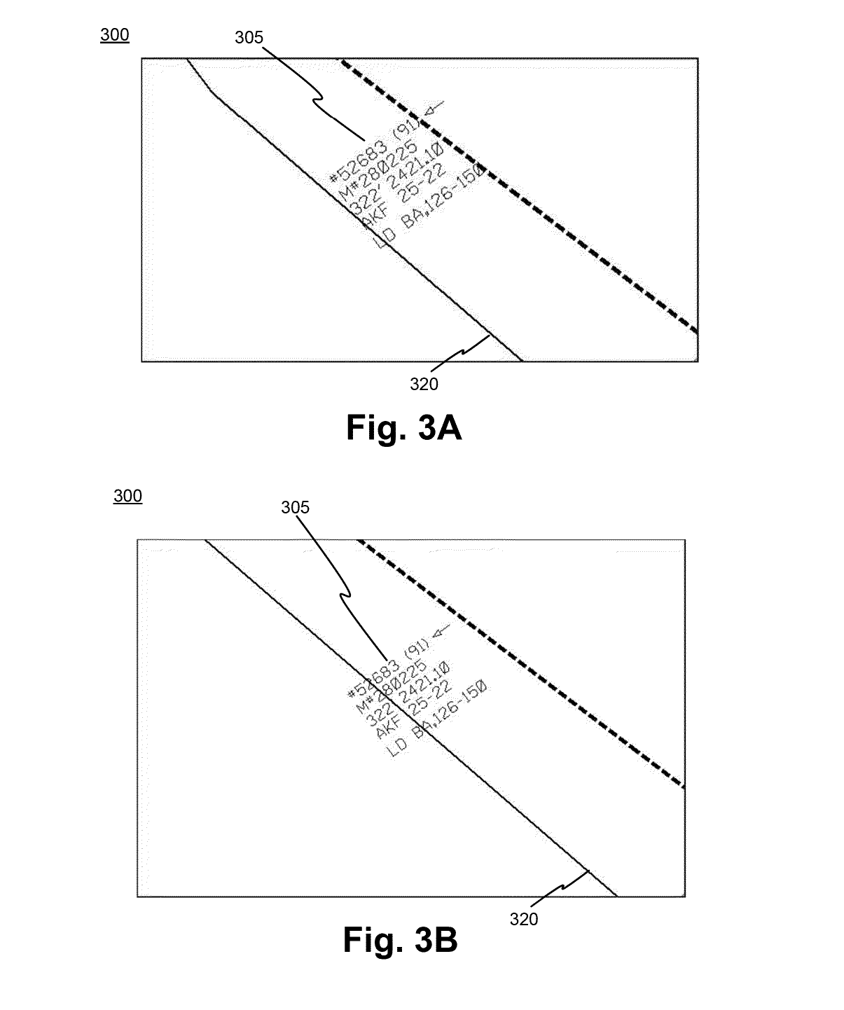

FIGS. 3A and 3B illustrate close ups of a geocoded map 300 before and after the correction of an OSP element 305. In FIG. 3A, geocoded map 300 shows an OSP element 305 exhibiting significant position error after the conversion and conflation process. While the GDT street line 320 was used for control, OSP element 305 was displaced away from its actual position on GDT street line 320. The position of OSP element 305 after correction is shown in FIG. 3B, moved to the left and down (south-west) in map 300. Such errors may come from a variety of sources, such as, for example, errors in equipment and/or human error in the original measurements (e.g., of OSP element 305, a control point, terrain, etc.); limitations in the equipment making the original measurements of OSP element 305, a control point, and/or terrain (e.g., measurement drift in inertial navigation sensors, surveying errors, etc.); and/or errors in the generation of land base map and/or errors in placement of an OSP element and/or a control point.

Specifications for the position accuracy of OSP elements can be fairly stringent given, for example, the density of urban environments and the number of OSP elements involved in the design and realization of a sophisticated telecommunications network. In one example, OSP elements may have an accuracy specification of being within a 0.2% deviation from the recorded data, which may translate to positional accuracies of approximately five feet. Positional accuracy of OSP elements may be an assessment of the closeness of the location of the OSP elements in the geocoded map in relation to their true positions on the earth's surface. The positional accuracy generally includes a horizontal accuracy assessment, a vertical accuracy assessment, and an explanation of how the accuracy assessments were determined. This analysis includes considering the inherent error (source error) and operational error (introduced error). The measurement of positional errors of equipment can be difficult, as an error is determined by comparing the estimated position of the unit with some accurate reference position.

Conventional approaches to test for accuracy after conversion and conflation involve a manual process which is extremely time consuming and prone to human error. Human operators can easily identify gross errors, however errors exceeding specifications can easily be overlooked by human operators. As will be described in more detail below with respect to FIGS. 4 and 5, embodiments described herein can automatically verify geocoded maps for position accuracy of OSP elements, and quickly check individual segments for OSP element position errors over large datasets. Segments having OSP position errors which exceed specification can be isolated and flagged for operator correction. Moreover, embodiments can provide the operator statistics indicating ranked categories of OSP position deviations, and can further provide graphical information which illustrates segments on a geocoded map, and may display the segments in a manner which indicates their associated OSP position deviation.

FIG. 4 is a diagram of a segment 400 illustrating an exemplary approach for computing the deviations of spatial metrics used in performing the geometric analysis of a segment 400. Embodiments may automatically perform the geometric analysis to facilitate the accurate position determination of OSP elements in geocoded map 200.

Segment 400 may include OSP element 410 (which in this case is a terminal), a GDT street line 420 which may be used to establish a first control point (C₁), and second control point (C₂) which was established earlier by measurements, such as surveying. Note that only one control point is required for computing the spatial metrics, but accuracy may be improved by using multiple control points and statistically combining the results.

Embodiments described herein may be used to automatically verify the positions of OSP elements in geocoded map 200. For segment 400, both in the land base map 100 and in the geocoded map 200 (specifically, the segment in geocoded map 200 which corresponds to the segment in land base map 100 after conversion and conflation), spatial metrics may be determined based on the positions of OSP element(s) and the control points. The deviations of the spatial metrics computed in land base map 100 and the geocoded map 200 may be determined and compared to evaluate quality of the positions of OSP elements in the geocoded map 200. The spatial metrics may include, for example, measured distances between OSP elements and control points, measured angles between OSP elements and control points, vectors between OPS elements and control points, etc. For example, the distance D1 between OSP element 410 and C₁ may be determined in both land base map 100 and geocoded map 200. When GDT control line 420 is used to establish a control point (e.g., C₁), the minimum distance from GDT control 420 to OSP element 410 is typically computed, so the angle to the OSP element (A₁) in such a case is typically 90 degrees. Additionally, using control point C₂, the distance D₂ and angle A₂ to OSP element 410 may be determined for segment 400 in both land base map 100 and geocoded map 200.

Spatial metrics from land base map 100 may then be compared to the corresponding spatial metrics determined in geocoded map 200. The comparisons may include computing deviations based on simple differences, statistical measures, ratios, etc. For example, with respect to segment 400 in FIG. 4, an example deviation may be computed as the absolute value of D₁(land base map)−D₁(geocoded map). Various comparisons between the angles, e.g., the absolute value of A₁(land base map)−A₁(geocoded map) may also be performed and combined with the computed deviations of distance. If additional control points are available (e.g., C₂), more comparisons (e.g., using distances D₂ and/or angles A₂) may be made and statistically combined to statistically improve the quality of the results. If multiple OSP elements are included in segment being analyzed, further measurements may be made, and the segment may be characterized based on OSP element having the maximum deviation. Embodiments may perform geometric analysis as described above on all of the appropriate segments in the region to provide various data and graphical outputs detailed below.

FIG. 5 is a diagram showing an exemplary graphical output 500 of the results of the comparisons of the geometric analysis performed over all the appropriate segments. Graphical output 500 may include a display window 505 showing the segments 510 superimposed over a geocoded map. Graphical output 500 may also include a control window 520 which may accept operator inputs to control the appearance of display window 505. Control window 520 may also provide a legend 530 indicating categories of ranges of deviations (e.g., distance deviations computed per segment as described in FIG. 4). Specifically, all of the deviations computed in the geometric analysis for the segments may be categorized into discrete ranges 535, where the entire set of categories may span a minimum and maximum value set by the operator in entry field 540 (e.g., min=0 and max=15). A count 537 of the number of segments falling into each category may be shown in legend 530 (e.g., the category having a range of deviation from 0 to 3 includes 212 segments).

Each category may be visually labeled using, for example, a different color, pattern, texture, text element, height (if 3-D maps are being used), etc. Visually labeled segments may be shown in their respective positions on the geocoded map in display window 505. Segments not having a visual label may not fall within the overall range set by the operator in entry field 540, or may not have OSP elements or control points to provide a basis for performing geometric analysis to determine deviations for spatial metrics.

The visual display of the segments 510 in the display window 505 with their associated visual labeling provides the operator with an easy way to study and efficiently isolate problem segments which may require manual correction. For example, the two “problem” segments 562 and 564, which are associated with category 560 having a range deviation between 10-15, may be shown using a label that stands out to the operator in display window 505 (e.g., displayed using diamond pattern). The geocoded map shown in display 505 may be simplified by cleaning up lines, junctions, and various other visual indicators to make interpretation by the operator easier. However, the operator may have the option of overlaying OSP information, geographic landmarks, control points (e.g., GDT street lines), etc., if desired.

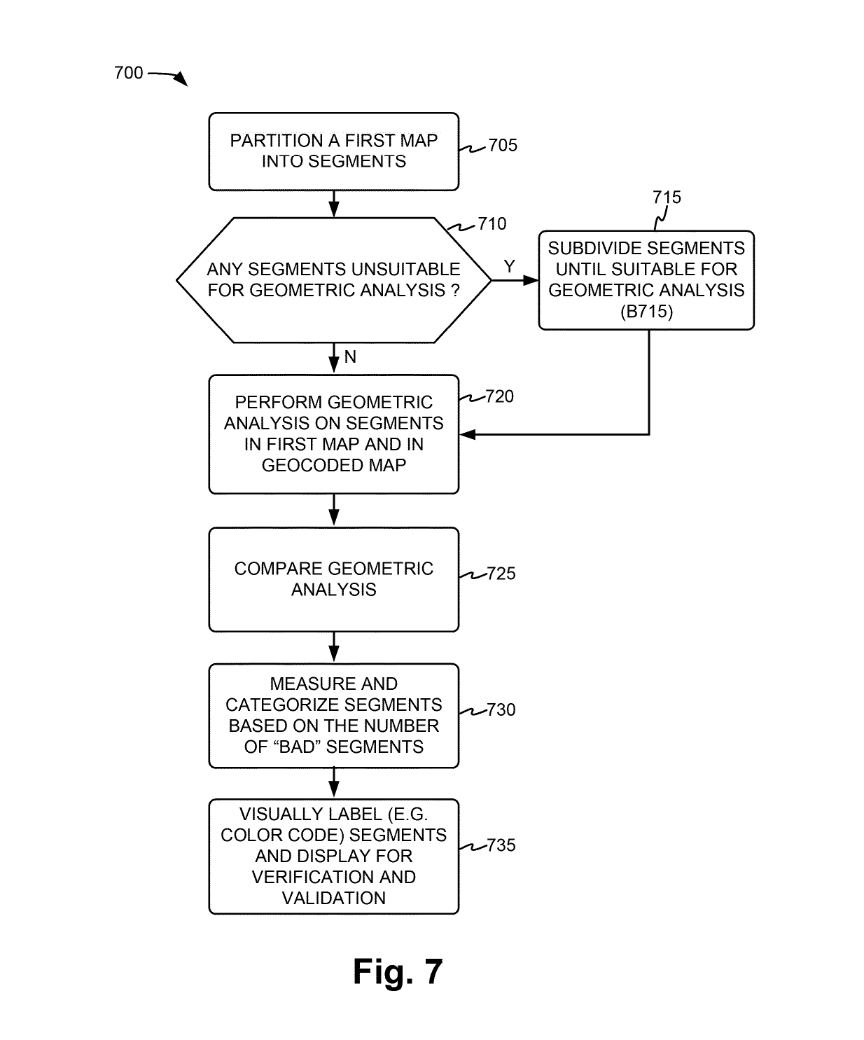

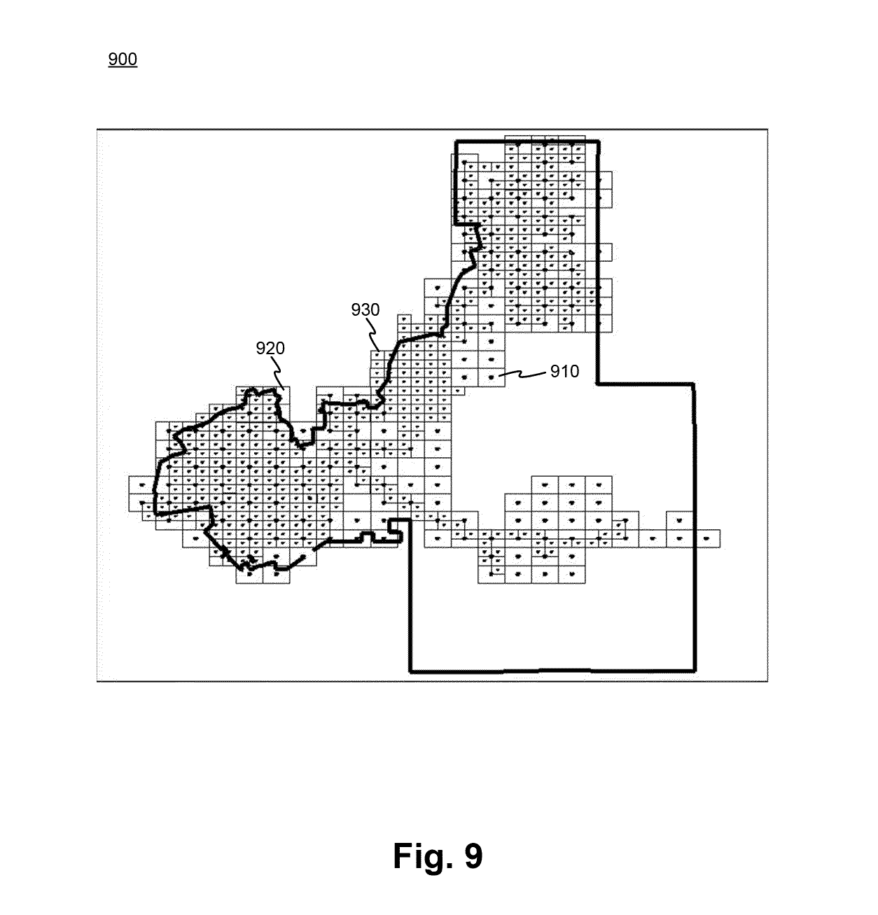

Moreover, the operator may also have options for changing the default segment size (e.g., Coarse or Fine) using entry field 550. Segment sizes may be reduced from the default size if required for performing geometric analysis, as will be explained in relation to FIGS. 7 and 9. As can be seen in display window 505, the segments default size was selected as coarse (e.g., “C” as opposed to fine “F”), but most of the segments were subdivided into smaller sizes so that geometric analysis could be accurately performed.

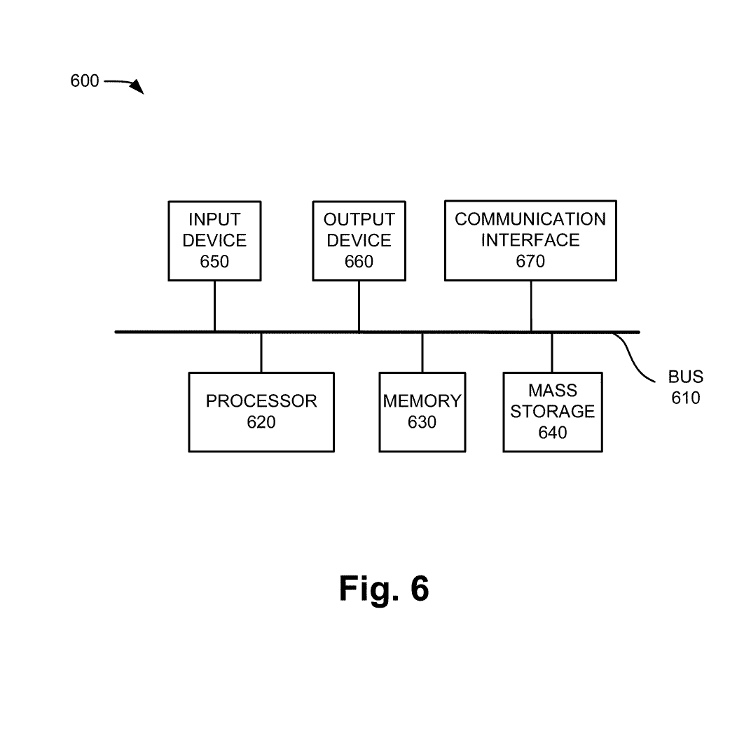

FIG. 6 is a block diagram showing exemplary components of a device 600 which may facilitate the accurate position determination of OSP elements. Device 600 may include a bus 610, a processor 620, a memory 630, mass storage 640, an input device 650, an output device 660, and a communication interface 670.

Bus 610 includes a path that permits communication among the components of device 600. Processor 620 may include any type of single-core processor, multi-core processor, microprocessor, latch-based processor, and/or processing logic (or families of processors, microprocessors, and/or processing logics) that interprets and executes instructions. In other embodiments, processor 620 may include an application-specific integrated circuit (ASIC), a field-programmable gate array (FPGA), and/or another type of integrated circuit or processing logic. For example, the processor 620 may be an x86 based CPU, and may use any operating system, which may include varieties of the Windows, UNIX, and/or Linux. The processor 620 may also use high-level analysis software packages and/or custom software written in any programming and/or scripting languages for interacting with other network entities.

Memory 630 may include any type of dynamic storage device that may store information and/or instructions, for execution by processor 620, and/or any type of non-volatile storage device that may store information for use by processor 620. For example, memory 630 may include a RAM or another type of dynamic storage device, a ROM device or another type of static storage device, and/or a removable form of memory, such as a flash memory. Mass storage device 640 may include any type of on-board device suitable for storing large amounts of data, and may include one or more hard drives, solid state drives, and/or various types of RAID arrays.

Input device 650, which may be optional, can allow an operator to input information into device 600, if required. Input device 650 may include, for example, a keyboard, a mouse, a pen, a microphone, a remote control, an audio capture device, an image and/or video capture device, a touch-screen display, and/or another type of input device. In some embodiments, device 600 may be managed remotely and may not include input device 650. Output device 660 may output information to an operator of device 600. Output device 660 may include a display (such as an LCD), a printer, a speaker, and/or another type of output device. In some embodiments, device 600 may be managed remotely and may not include output device 660.

Communication interface 670 may include a transceiver that enables device 600 to communicate (both wired and/or wirelessly) within a local area network and/or across a wide area network to access external resources, such as, for example, the Internet. Specifically, communication interface 670 may be configured for wireless communications (e.g., Radio Frequency (RF), infrared, and/or visual optics, etc.), wired communications (e.g., conductive wire, twisted pair cable, coaxial cable, transmission line, fiber optic cable, and/or waveguide, etc.), or a combination of wireless and wired communications. Communication interface 670 may include a transmitter that converts baseband signals to RF signals and/or a receiver that converts RF signals to baseband signals. Communication interface 670 may be coupled to one or more antennas for transmitting and receiving RF signals. Communication interface 670 may include a logical component that includes input and/or output ports, input and/or output systems, and/or other input and output components that facilitate the transmission/reception of data to/from other devices. For example, communication interface 670 may include a network interface card (e.g., Ethernet card) for wired communications and/or a wireless network interface (e.g., a WiFi) card for wireless communications. Communication interface 670 may also include a Universal Serial Bus (USB) port for communications over a cable, a Bluetooth® wireless interface, a Radio Frequency Identification (RFID) interface, a Near Field Communication (NFC) wireless interface, and/or any other type of interface that converts data from one form to another form.

As described below, device 600 may perform certain operations relating to facilitating the accurate position determination of OSP elements. Device 600 may perform these operations in response to processor 620 executing software instructions contained in a computer-readable medium, such as memory 630 and/or mass storage 640. The software instructions may be read into memory 630 from another computer-readable medium or from another device. The software instructions contained in memory 630 may cause processor 620 to perform processes described herein. Alternatively, hardwired circuitry may be used in place of, or in combination with, software instructions to implement processes described herein. Thus, implementations described herein are not limited to any specific combination of hardware circuitry and software.

Although FIG. 6 shows exemplary components of device 600, in other implementations, device 600 may include fewer components, different components, additional components, or differently arranged components than depicted in FIG. 6.

FIG. 7 is a flow diagram of an exemplary process 700 for facilitating accurate position determination of OSP elements. Process 700 may be performed by device 600, for example, by executing instructions on processor 620 which may be stored in memory 630 and/or mass storage 640. Device 600 may initially partition a first map (e.g., land base map 100) into a plurality of two-dimensional segments (block 705). Assume that the first map includes a representation of a layout for OSP elements within a region. In some embodiments, individual segments may be shaped as rectangles, and the plurality of segments form grids over a map.

Device 600 may then determine whether any segment(s) are unsuitable for a geometric analysis (block 710), and subdivide these identified segment(s) into smaller segments which are suitable for the geometric analysis (block 715). This identification may be based on measuring and thresholding the proximity between multiple OSP elements and/or control points within a segment. For example, device 600 may determine that a first OSP element is indistinguishable from a second OSP element based upon a distance below a predetermined threshold, an insufficiency in data used to identify an OSP, an ambiguity and/or a complexity of the geography associated with the identified segment. In another example, device 600 may determine that an ambiguity between a first control point and a second control point in the identified segment.

Subdividing the segments may reduce their complexity, as described below in relation to FIG. 9, and permit accurate geometric analysis. In some instances, where subdividing a segment does not render the segment suitable for geometric analysis, the segment may be flagged accordingly. Device 600 may provide the operator an option to specify at an initial size of the segment or a final size of the segment, where the final size provides a lower bound on how small the identified segments may be subdivided. Device 600 may then perform the geometric analysis on the segments in the first map (e.g., land base map 100) and on spatially corresponding segments in a geocoded map 200 (block 720).

Device 600 may then compare the geometric analysis of the segments in the first map and the geometric analysis of the spatially corresponding segments in the geocoded map (block 725). This comparison may include device 600 determining deviations between a first spatial metric(s) and a second spatial metric(s), which were calculated during geometric analysis, for each corresponding segment in the land base map and the geocoded map. Device 600 may then generate a comparative ranking based on the deviations. In an embodiment, when generating the comparative ranking, device 600 may establishing categories of ranges of the determined deviations between the first spatial metric and the second spatial metric, wherein the ranges are non-overlapping and have lower and upper bounds which are sorted in increasing order. Device 600 may then assign each segment to one of the established categories based upon the maximum determined deviation in each segment, count a number of segments assigned to each of the established categories, and assign a label each segment based upon the established category to which it is assigned. In an embodiment, for example, device 600 may measure and categorize segments based on the number of “bad” segments, where a “bad” segment may be determined based on the magnitude of the deviations determined during geometric analysis (block 730).

In an embodiment, device 600 may further provide output to the operator, where each segment is visually labeled and displayed, where the display may be used by an operator to verify and validate appropriate segments (e.g., segments indicated as “bad”) (block 735). For example, the display may be color coded by category, and to further to highlight bad segments. In some embodiments, the operator may manually perform the verification and validation to, for example, correct the bad segments. Device 600 may display each segment on the geocoded map based on the category of each segment, wherein each established category is labeled to be visually distinguished from the other categories. Device 600 may further distinguish each category visually based upon at least one of different colors, different patterns, or different heights. The categories, along with the associated number of segments, may be displayed by device 600 (e.g., legend 520) along with a geocoded map of the visually labeled segments (e.g., display window 505).

In some embodiments, device 600 may transform the first map (e.g., land base map 100) into geocoded map 200. This transformation may include having device 600 convert positions in the first map to coordinates consistent with the geocoded map of the region, and then perform conflation based on common control points in the first map and the geocoded map to match the first map to the geocoded map. In some embodiments, device 600 may transform positions in the first map into positions described in a reference coordinate frame compatible with standard Geographical Information Systems (GIS) formats.

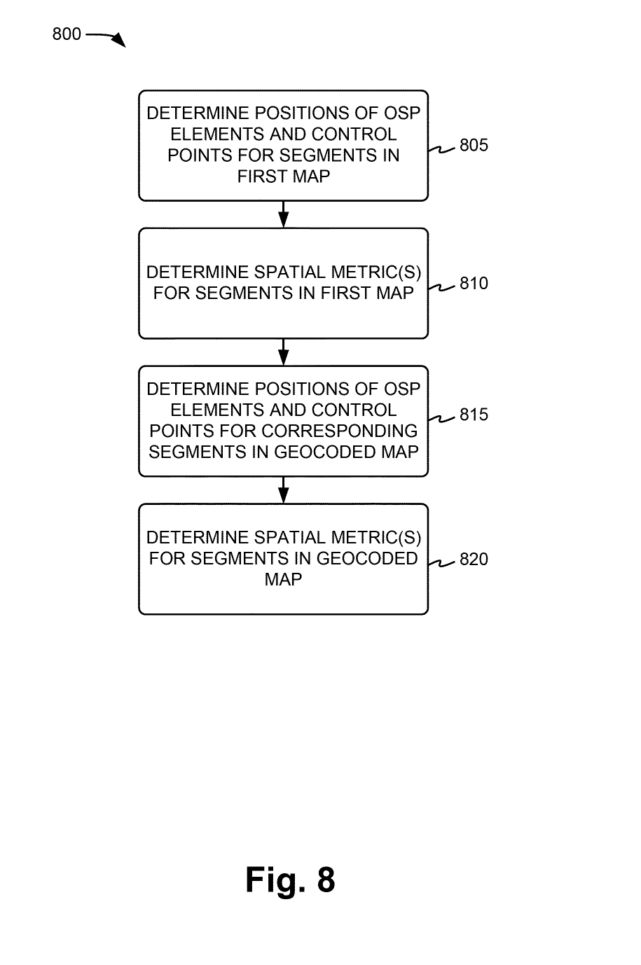

FIG. 8 a flow diagram of an exemplary process 800 for performing geometric analysis based on the OSP elements and control points. Geometric analysis may include device 600 determining positions of OSP element(s) and control point(s) for segments in first map 100 (block 805). Device 600 may then determine spatial metric(s) based on a position of the OSP element(s) and a position of control point(s) within segments in first map 100 (block 810). Device 600 may then determine positions of OSP element(s) and control point(s) for corresponding segments in geocoded map 200 (block 815). Device 600 may then determine spatial metric(s) based on a position of the OSP element(s) and a position of control point(s) within segments in geocoded map 200 (block 820).

The control points may include points derived from or lying on a GDT line. In some instances, the point selected on the GDT line may minimized the distance between the OSP element and the GDT line. Determining the spatial metrics may include calculating a distance, an angle, or a vector.

FIG. 9 is a diagram illustrating an exemplary geocoded map 900 having segments of various sizes superimposed thereon. As noted previously, embodiments herein may reduce the size of default sized segments if the segments are unsuitable for performing geometric analysis. This unsuitability may depend upon the complexity of the layout of OSP elements in the segment. For example, the positions of two or more OSP elements and/or control points may be indistinguishable when the segment size is set at the default value. Alternatively, various aspects of the terrain and/or man-made structures reflected in the geocoded map (e.g., subway, steam tunnels, etc.) may introduce issues for geometric analysis, especially in dense urban areas. Geocoded map 900 illustrates as an example segments having three different sizes. The coarse segment size 910 is the default size, while medium size segments 920 and fine size segments 930 were created (by sub-dividing the default size segments) in their respective locations to facilitate the geometric analysis process.

By sub-dividing a segment into smaller segments, the complexity of the larger segment may be reduced so that geometric analysis can be accurately performed. Additionally, if the geocoded maps are provided in a multi-scale format, sub-dividing the segments may present smaller scales to the geometric analysis algorithm, which would allow for the separation of OSP elements and/or control points which may have been previously indistinguishable when analyzed using larger scales.

In the preceding specification, various preferred embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense. For example, while a series of blocks has been described with respect to FIGS. 7 and 8, the order of the blocks may be modified in other implementations. Further, non-dependent blocks and signal flows may be performed in parallel.

It will be apparent that different aspects of the description provided above may be implemented in many different forms of software, firmware, and hardware in the implementations illustrated in the figures. The actual software code or specialized control hardware used to implement these aspects is not limiting of the invention. Thus, the operation and behavior of these aspects were described without reference to the specific software code. It being understood that software and control hardware can be designed to implement these aspects based on the description herein.

Further, certain portions of the invention may be implemented as a “component” or “system” that performs one or more functions. These components/systems may include hardware, such as a processor, an ASIC, a FPGA, or other processing logic, or a combination of hardware and software.

No element, act, or instruction used in the present application should be construed as critical or essential to the invention unless explicitly described as such. Also, as used herein, the article “a” and “one of” is intended to include one or more items. Further, the phrase “based on” is intended to mean “based, at least in part, on” unless explicitly stated otherwise.

What is claimed is:

1. A method, comprising:
partitioning a first map into a plurality of segments, wherein the first map represents a layout for outside plant (OSP) elements within a region;
identifying at least one segment of the plurality of segments that is unsuitable for a geometric analysis;
subdividing the at least one identified segment into smaller segments, until the smaller segments are suitable for the geometric analysis;
performing the geometric analysis on the segments in the first map and on spatially corresponding segments in a geocoded map; and
comparing the geometric analysis of the segments in the first map and the geometric analysis of the spatially corresponding segments in the geocoded map.

2. The method of claim 1, wherein the partitioning the first map comprises:
partitioning a land base map into a plurality of grids, wherein the land based map provides a design configuration of the OSP elements in the region.

3. The method of claim 1, further comprising:
providing a user with an option to specify at least one of an initial size of the segments or a final size of an identified segment, wherein the final size provides a bound for subdividing identified segments.

4. The method of claim 1, further comprising:
transforming the first map into the geocoded map, wherein the transforming comprises:
converting positions in the first map to coordinates consistent with the geocoded map of the region; and
performing conflation based on common control points in the first map and the geocoded map to match the first map to the geocoded map.

5. The method of claim 4, wherein converting positions comprises:
transforming positions in the first map into positions referenced to a reference coordinate frame compatible with standard Geographical Information Systems (GIS) formats.

6. The method of claim 1, wherein identifying at least one segment of the plurality of segments that is unsuitable for a geometric analysis further comprises:
determining that a first OSP element is indistinguishable from a second OSP element based upon at least one of: a distance below a predetermined threshold, an insufficiency in data used to identify an OSP element, an ambiguity or a complexity of the geography associated with the at least one segment.

7. The method of claim 1, wherein identifying at least one segment of the plurality of segments that is unsuitable for a geometric analysis further comprises:
determining an ambiguity between a first control point and a second control point in the at least one segment.

8. The method of claim 1, wherein performing the geometric analysis further comprises:
determining at least one first spatial metric based on a position of at least one OSP element and a position of at least one control point within each segment in the first map; and
determining at least one second spatial metric based on a position of the at least one OSP element and a position of the at least one control point in a corresponding segment in the geocoded map.

9. The method of claim 8, wherein the at least one control point includes a point on a GDT line which minimizes the distance between the OSP element and the GDT line.

10. The method of claim 8, wherein determining at least one of the first or second spatial metric comprises:
calculating at least one of a distance, an angle, or a vector.

11. The method of claim 8, wherein comparing the geometric analysis further comprises:
determining deviations between the at least one first spatial metric and the at least one second spatial metric for each corresponding segment in the first map and the geocoded map; and
generating a comparative ranking based on the deviations.

12. The method of claim 11, wherein generating a comparative ranking comprises:
establishing categories of ranges of the determined deviations between the first spatial metric and the second spatial metric, wherein the ranges are non-overlapping and have lower and upper bounds which are sorted in increasing order;
assigning each segment to one of the established categories based upon the maximum determined deviation in each segment;
counting a number of segments assigned to each of the established categories; and
labeling each segment based upon the established category to which it is assigned.

13. The method of claim 12, further comprising:
displaying each segment on the geocoded map based on the assigned category of each segment, wherein each established category is labeled to be visually distinguished from the other categories.

14. The method of claim 12, further comprising:
distinguishing each category visually based upon at least one of different colors, different patterns, or different heights.

15. A device, comprising:
a memory to store instructions; and
a processor, coupled to the memory, configured to execute the instructions stored in memory to:
partition a first map into a plurality of segments, wherein the first map represents a layout for outside plant (OSP) elements within a region,
identify at least one segment of the plurality of segments that is unsuitable for a geometric analysis,
subdivide the at least one identified segment into smaller segments, until the smaller segments are suitable for the geometric analysis,
perform the geometric analysis on the segments in the first map and on spatially corresponding segments in a geocoded map, and
compare the geometric analysis of the segments in the first map and the geometric analysis of the spatially corresponding segments in the geocoded map.

16. The device of claim 15, wherein the instructions to partition the first map cause the processor to:
partition a land base map into a plurality of grids, wherein the land based map provides a design configuration of the OSP elements in the region.

17. The device of claim 15, wherein the instructions to identify at least one segment of the plurality of segments that is unsuitable for a geometric analysis causes the processor to:
determine that a first OSP element is indistinguishable from a second OSP element based upon at least one of: a distance below a predetermined threshold, an insufficiency in data used to identify an OSP element, an ambiguity or a complexity of the geography associated with the at least one segment.

18. The device of claim 15, wherein the instructions to perform the geometric analysis cause the processor to:
determine at least one first spatial metric based on a position of at least one OSP element and a position of at least one control point within each segment in the first map, and
determine at least one second spatial metric based on a position of the at least one OSP element and a position of the at least one control point in a corresponding segment in the geocoded map.

19. The device of claim 18, wherein the instructions to compare the geometric analysis cause the processor to:
determine deviations between the at least one first spatial metric and the at least one second spatial metric for each corresponding segment in the land based map and the geocoded map, and
generate a comparative ranking based on the deviations.

20. The device of claim 19, wherein the instructions to generate a comparative ranking cause the processor to:
establish categories of ranges of the determined deviations between the first spatial metric and the second spatial metric, wherein the ranges are non-overlapping and have lower and upper bounds,
assign each segment to one of the established categories based upon the maximum determined deviation in each segment,
count a number of segments assigned to each of the established categories, and
label each segment based upon the established category to which it is assigned.

21. The device of claim 20, wherein the instructions further cause the processor to:
display each segment on the geocoded map based on the assigned category of each segment, wherein each established category is labeled to be visually distinguished from the other categories.

22. The device of claim 21, wherein the instructions further the processor to:
distinguish each category visually based upon at least one of different colors, different patterns, or different heights.

23. A non-transitory computer-readable medium comprising instructions, which, when executed by a processor, cause the processor to:
partition a first map into a plurality of segments, wherein the first map represents a layout for outside plant (OSP) elements within a region;
identify at least one segment of the plurality of segments that is unsuitable for a geometric analysis;
subdivide the at least one identified segment into smaller segments, until the smaller segments are suitable for the geometric analysis;
perform the geometric analysis on the segments in the first map and on spatially corresponding segments in a geocoded map; and
compare the geometric analysis of the segments in the first map and the geometric analysis of the spatially corresponding segments in the geocoded map.
